(19) United States
(12) Patent Application Publication
(10) Pub. No.: US 2020/0140702 A1
(43) Pub. Date: May 7, 2020

(54) CURING AGENT FOR COATING COMPOSITION FOR FORMING SELF-RESTORABLE LAYER, COATING COMPOSITION HAVING THE SAME AND METHOD FOR COATING AUTOMOBILE EXTERIOR USING THE SAME

(71) Applicant: NOROO BEE Chemical Co., Ltd., Cheonan-Si (KR)

(72) Inventors: Jae Beom Ahn, Anyang-si (KR); Hoonkwan Joo, Cheonan-si (KR); Dae Geun Oh, Cheonan-si (KR); Sung Do Kim, Daejeon (KR); Sung Kyu Lee, Incheon (KR)

(73) Assignee: NOROO BEE Chemical Co., Ltd., Cheonan-Si (KR)

(21) Appl. No.: 16/674,481

(22) Filed: Nov. 5, 2019

(30) Foreign Application Priority Data
Nov. 6, 2018 (KR) 10-2018-0134876

(51) Int. Cl. C09D 7/65; B05D 7/00; B05D 3/00; C09D 167/04; C08G 18/42; C08G 18/73

(52) U.S. Cl. CPC C09D 7/65; B05D 7/586; C08G 18/73; C09D 167/04; C08G 18/4213; B05D 3/002

(57) ABSTRACT

A curing agent includes a polyisocyanate. The polyisocyanate is obtained by reaction of a polyester polyol and a diisocyanate. The polyester polyol has 500 to 2,000 of a weight average molecular weight and 5% to 10% of a hydroxyl group content.

### CROSS-REFERENCE TO RELATED APPLICATION

This application claims priority under 35 USC § 119 to Korean Patent Application No. 10-2018-0134876, filed on Nov. 6, 2018 in the Korean Intellectual Property Office (KIPO), the contents of which are herein incorporated by reference in their entirety.

### BACKGROUND

### 1. Field

Exemplary embodiments relate to a coating composition. More particularly, exemplary embodiments relate to a curing agent for a coating composition for forming self-restorable layer, a coating composition having the same and a method for coating an automobile using the same.

### 2. Description of the Related Art

Recent coating technology is being converted into a smart intelligent coating technology, which adds new functions such as self-restoring, self-cleaning, stimulation-responsiveness or the like, from a conventional coating technology that mainly purposes primarily protecting an object against an external environment and improving aesthetic appearance of the object.

A scratch-resistant self-restoring coating technology may be defined as a technology forming a coating layer capable of self-restoring damage of a surface caused by an external stimulation.

In particular, as time passes, 1˜3 μm level scratches appear on an entire surface of a external coating layer of an automobile. As a result, a glossy and a clearness of a coating layer is visually reduced, and a haze is increased. Thus, a commercial value of the automobile may be reduced, and purchasing desire of consumers may be reduced. Thus, demand of the self-restoring coating technology is high.

A polyurethane resin using a curing agent including a polyisocyanate containing aliphatic diisocyanate or alicyclic diisocyanate may form a coating layer having a superior chemical resistance, flexibility, weather resistance or the like. In order to increase a compliance of a coating layer, the polyisocyanate may be formed by a polyol.

For example, Japanese Laid-Open Patent Publication No. 1998-007757 discloses an isocyanate composition using a polyester polyol. Japanese Laid-Open Patent Publication No. 1998-168155 discloses an isocyanate composition using a polyether polyol. However, a coating layer formed of the composition of Japanese Laid-Open Patent Publication No. 1998-007757 has a low water resistance, and a coating layer formed of the composition of Japanese Laid-Open Patent Publication No. 1998-168155 has a low heat resistance and contamination resistance.

### SUMMARY

The present invention in accordance with exemplary embodiments provides a curing agent for a coating composition capable of forming a coating layer having a great scratch-restorability and a high strength to solve the above-mentioned problems.

The present invention in accordance with other embodiments provides a coating composition including the curing agent.

The present invention in accordance with other embodiments provides a method for coating an automobile exterior using the coating composition.

According to an exemplary embodiment, a curing agent includes a polyisocyanate. The polyisocyanate is obtained by reaction of a polyester polyol and a diisocyanate. The polyester polyol has 500 to 2,000 of a weight average molecular weight and 5% to 10% of a hydroxyl group content.

In an exemplary embodiment, the polyester polyol is represented by the following Chemical Formula 1, wherein each of a, b, c, d, e, f and g independently represent a natural number.

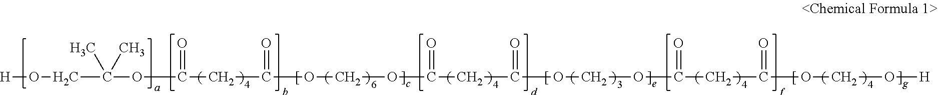

In an exemplary embodiment, the curing agent has 73 wt % to 77 wt % of a solid content, 6 wt % to 7 wt % of an NCO content and 100 to 200 mPa·s of a viscosity at 25° C.

In an exemplary embodiment, the polyester polyol is represented by the following Chemical Formula 2, wherein each of p, q and r independently represent a natural number.

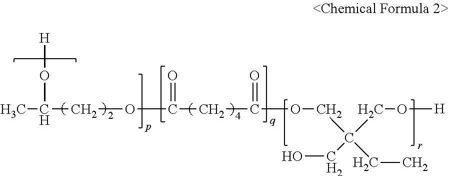

In an exemplary embodiment, the curing agent has 78 wt % to 82 wt % of a solid content, 7 wt % to 8 wt % of an NCO content and 300 to 400 mPa·s of a viscosity at 25° C.

In an exemplary embodiment, the curing agent further includes 200 to 250 parts by weight of hexamethylene diisocyanate trimer with respect to 100 parts by weight of a solid content of the polyisocyanate.

In an exemplary embodiment, the diisocyanate is an aliphatic diisocyanate.

According to an exemplary embodiment, a coating composition for forming a self-restoring layer includes a main agent and the above curing agent. The main agent includes 5 wt % to 20 wt % of a caprolactone-modified hyperbranched polyester polyol, 30 wt % to 50 wt % of a first acrylic resin having a hydroxyl group, 15 wt % to 25 wt % of a second acrylic resin having a hydroxyl group and having a glass transition temperature higher than that of the first acrylic resin and an extra solvent. The caprolactone-modified hyperbranched polyester polyol is obtained from a polyhydric alcohol including caprolactone triol.

According to an exemplary embodiment, a method for coating an automobile exterior includes pretreating a surface of an object to be coated, forming an electro-deposited layer on the surface of the object, forming a middle primer layer on the electro-deposited layer, forming a base color layer on the middle primer layer, coating the above coating composition on the base color layer, and heat-treating the coating composition to form a cured coating layer.

According to exemplary embodiments, a chemical resistance, a heat resistance, a solvent resistance, a water resistance, an acid resistance, an impact resistance and a weather resistance of a coating layer may be improved.

### DESCRIPTION OF EMBODIMENTS

The present invention may make various changes and may take various forms, and specific embodiments may be described in detail. However, it is to be understood that the present invention is not limited to the specific embodiments, but covers all modifications, equivalents and alternatives included in the spirit and scope of the present invention.

The terms first, second, or the like. may be used to describe various elements, but the elements should not be limited by the terms. The terms are used only for the purpose of distinguishing one element from another. For example, without departing from the scope of the present invention, a first element may be referred to as a second component, and similarly, a second component may also be referred to as a first component.

The terminology used herein is for the purpose of describing particular exemplary embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

Elastic Polyisocyanate Curing Agent

An elastic polyisocyanate according to an exemplary embodiment may be obtained by reaction a polyester polyol with a diisocyanate.

The polyester polyol may be obtained by reaction a polyfunctional acid or its derivative with a polyhydric alcohol. The reaction may be progressed under a condition including a catalyst. In an exemplary embodiment, the weight average molecular weight of the polyester polyol may be 500 to 2000, and a hydroxyl group content of the polyester polyol may be 5% to 10%.

For example, the polyfunctional acid or its derivative may include terephthalic acid, isophthalic acid, phthalic acid, anhydrous phthalic acid, naphthalene dicarboxylate, biphenyl dicarboxylate, oxalic acid, malonic acid, succinic acid, succinic anhydride, glutaric acid, adipic acid, pimelic acid, suberic acid, azelaic acid, sebacic acid, itaconic acid or the like. These may be used each alone or in a combination thereof. Furthermore, monocarboxylic acid may be added thereto as desired.

For example, the polyhydric alcohol may include ethylene glycol, 1,2-propanediol, 1,3-propanediol, 1,2-butanediol, 1,3-butanediol, 1,4-butanediol, 1,5-pentanediol, 1,6-hexanediol, 1,7-heptanediol, 1,8-octanediol, 1,9-nonanediol, 2-ethyl-1,6-hexanediol, 2-methyl-1,3-propanediol, 3-methyl-1,5-pentanediol, neopentylglycol, 1,3-cyclohexanediol, 1,4-cyclohexanediol, 2,2′-bis(4-hydroxycyclohexyl)-propane, p-xylylenediol, p-tetrachloroxylylenediol, 1,4-dimethylolcyclohexane, bishydroxymethyltetrahydrofuran, di (2-hydroxyethyl) dimethylhydantoin, diethylene glycol, dipropylene glycol, polypropylene glycol, polytetramethylene glycol, 2,6′-dihydroxyethylhexyl ether, 2,4′-dihydroxyethylbutyl ether, 2,5′-dihydroxyethylpentyl ether, 2,3′-dihydroxy-2′,2′-dimetylethylpropyl ether, thioglycol, trimethylol propane or the like. These may be used each alone or in a combination thereof. Furthermore, a monoalcohol may be added thereto as desired.

For example, the polyfunctional acid includes adipic acid, and the polyhydric alcohol includes neopentylglycol, 1,6-hexanediol, 1,3-propanediol and 1,4-butanediol. Preferably, a monomer mixture including the polyfunctional acid or its derivative and the polyhydric alcohol may include 15 wt % to 20 wt % of neopentylglycol, 15 wt % to 20 wt % of 1,6-hexanediol, 5 wt % to 10 wt % of 1,3-propanediol, 8 wt % to 12 wt % of 1,4-butanediol and 40 wt % to 55 wt % of adipic acid.

The polyester polyol obtained by the above mixture may be represented by the following Chemical Formula 1. In Chemical Formula 1, each of a, b, c, d, e, f and g independently represent a natural number, which may be determined by the mixing ratio of the monomers and the molecular weight.

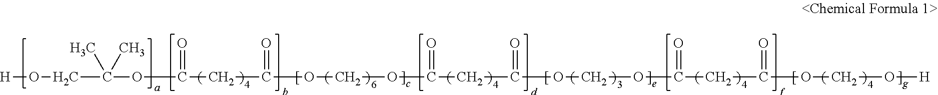

In an exemplary embodiment, the polyhydric alcohol may have at least three hydroxyl groups. For example, the polyhydric alcohol may include trimethylol propane and 1,3-butanediol. Using the polyhydric alcohol having at least three hydroxyl groups may form a polyisocyanate having a branch shape thereby increasing an elasticity of a coating layer. Preferably, a monomer mixture including the polyfunctional acid or its derivative and the polyhydric alcohol may include 25 wt % to 35 wt % of 1,3-butanediol, 15 wt % to 25 wt % of trimethylol propane and 40 wt % to 60 wt % of adipic acid.

The polyester polyol obtained by the above mixture may be represented by the following Chemical Formula 2. In Chemical Formula 2, each of p, q and r independently represent a natural number, which may be determined by mixing ratio of the monomers and the molecular weight.

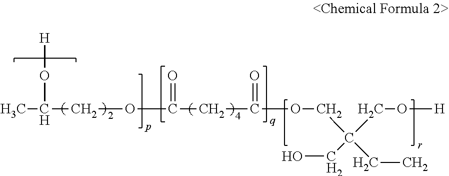

The polyester polyol may react with an excessive amount of a diisocyanate to form a polyisocyanate.

The diisocyanate may include an aliphatic diisocyanate, a cycloaliphatic diisocyanate or a combination thereof.

For example, the diisocyanate may include 1,6-hexamethylene diisocyanate, 1,12-dodecane diisocyanate, cyclobutane-1,3-diisocyanate, cyclohexane-1,3-diisocyanate, cyclohexane-1,4-diisocyanate, isophorone diisocyanate (IPDI) or the like. These can be used each alone or in a combination thereof. In an exemplary embodiment, the diisocyanate may include an aliphatic diisocyanate, and preferably 1,6-hexamethylene diisocyanate.

For example, the polyester polyol represented by Chemical Formula 1 may react with 1,6-hexamethylene diisocyanate thereby forming a polyisocyanate represented by the following

Chemical Formula 3.

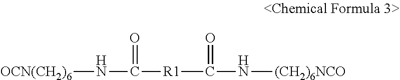

In Chemical Formula 3, R1 represents a moiety derived from the polyester polyol of Chemical Formula 1. For example, R1 may be represented by R2 or R2-R3-R2. R2 may be represented by the following Chemical Formula 4. R3 may be represented by the following Chemical Formula 5. In Chemical Formula 4, each of a, b, c, d, e, f, and g independently represent a natural number. In Chemical Formula 5, m represents a natural number.

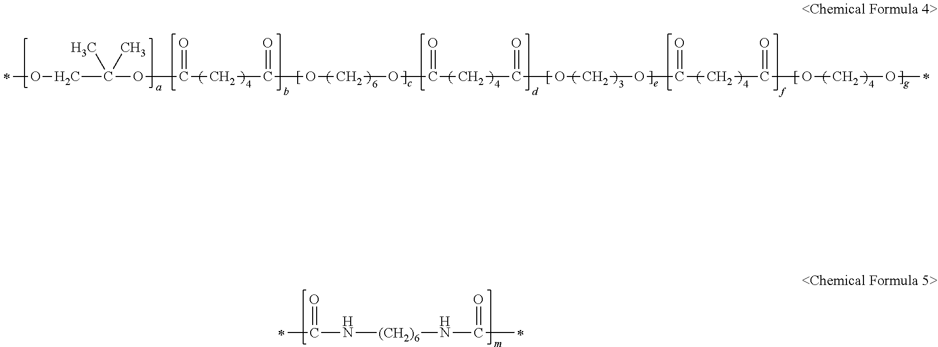

For example, a polyisocyanate obtained by reaction of the polyester polyol represented by Chemical Formula 2 and 1,6-hexamethylene diisocyanate may be represented by the following Chemical Formula 6.

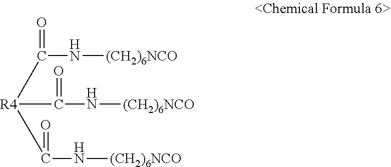

In Chemical Formula 6, R4 represents a moiety derived from the polyester polyol of Chemical Formula 2. For example, R4 may be represented by the following Chemical Formula 7. In Chemical Formula 7, p, q and r independently represent a natural number.

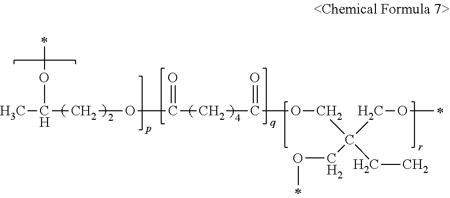

The reaction product of the polyester polyol and the diisocyanate may be purified to remove a remaining diisocyanate, which has not reacted.

The diisocyanate has a low vapor pressure, and may be harmful for a human body. Furthermore, an NCO group of the diisocyanate has a high reactivity with a hydroxyl group. Thus, when the diisocyanate remains in the reaction product, a storage reliability of the reaction product may be reduced.

In an exemplary embodiment, a distillation purification process using a thin film evaporator may be performed to remove the remaining diisocyanate and to obtain the purified polyisocyanate.

A process pressure of the distillation purification process may be properly adjusted depending on a composition and a temperature of the polyisocyanate, an evaporation device or the like. For example, the process pressure may be 0.01 kPa to 10 MPa, and preferably 0.1 kPa to 1 MPa, and more preferably 0.5 kPa to 50 kPa.

A process temperature of the distillation purification process may be properly adjusted depending on a composition and a temperature of the polyisocyanate, an evaporation device or the like. When the process temperature is too high, the polyisocyanate may be denatured by heat. When the process temperature is too low, a cooling device may be further required, or industrial application may be difficult. For example, the process temperature may be 50° C. to 300° C., and preferably 80° C. to 300° C., and more preferably 100° C. to 250° C.

Synthesis of the polyisocyanate may be performed in a condition including a catalyst such as dibutyl tin dilaurate, dibutyl tin oxide. In an exemplary embodiment, synthesis of the polyisocyanate may be performed without a solvent.

The polyisocyanate may be used for a curing agent for forming a urethane coating layer. For example, a weight average molecular weight of the polyisocyanate may be 1,000 to 3,000.

For example, the curing agent may include the polyisocyanate and a solvent. The solvent may include diethyl ether, tetrahydrofuran, acetone, 2-butanone, methyl isobutyl ketone, ethyl acetate, butyl acetate, benzene, toluene, chlorobenzene, o-dichlorobenzene, xylene, methoxyethyl acetate, methoxypropyl acetate, ethyl-3-ethoxy propionate, dimethylformamide, dimethylacetamide, propylene glycol monomethyl ether acetate, solvent naphtha or the like. These can be used each alone or in a combination thereof.

The solvent may be selected or combined depending on repeating units included in the polyisocyanate. For example, a solvent for the polyisocyanate represented by Chemical Formula 3 may include a mixture of toluene and propylene glycol monomethyl ether acetate (PMAc), and a solvent for the polyisocyanate represented by Chemical Formula 6 may include n-butyl acetate.

In an exemplary embodiment, a curing agent including the polyisocyanate represented by Chemical Formula 3 may have 73 wt % to 77 wt % of a solid content, 6 wt % to 7 wt % of an NCO content and 100 to 200 mPa·s of a viscosity at 25° C.

In an exemplary embodiment, a curing agent including the polyisocyanate represented by Chemical Formula 6 may have 78 wt % to 82 wt % of a solid content and 7 wt % to 8 wt % of an NCO content and 300 to 400 mPa·s of a viscosity at 25° C.

In an exemplary embodiment, a curing agent may further include a diisocyanate trimer. For example, the curing agent may further include hexamethylene diisocyanate trimer (HDI trimer) to increase a yellowing resistance and a weather resistance of a coating layer.

In an exemplary embodiment, the content of the diisocyanate trimer may be 30 to 250 parts by weight, and preferably 200 to 250 parts by weight with respect to 100 parts by weight of a solid content of the polyisocyanate. When the content of the diisocyanate trimer is too small, a solvent resistance of a coating layer may be reduced. When the content of the diisocyanate trimer is too high, extensibility of a coating layer may be reduced.

Coating Composition for Forming a Self-Restoring Layer

A coating composition according to an exemplary embodiment may be a two-liquid type coating composition including a main agent and a curing agent. The curing agent may be same as the previously explained polyisocyanate-containing curing agent. Thus, a composition of the main agent will be explained more fully, hereinafter.

In an exemplary embodiment, the main agent includes (a) a caprolactone-modified hyperbranched polyester polyol, (b) a first acrylic resin, (c) a second acrylic resin and (d) a solvent. The coating composition may further include (e) additives such as a reaction catalyst, a wetting agent, a light stabilizer, or the like as desired.

(a) Caprolactone-Modified Hyperbranched Polyester Polyol

The caprolactone-modified hyperbranched polyester polyol may have a hyperbranched structure formed by the reaction of a caprolactone polyol and a polyfunctional acid.

For example, the caprolactone-modified hyperbranched polyester polyol may be obtained by reaction a polyfunctional acid or a derivative thereof, a diol compound and the caprolactone polyol.

For example, the diol compound may include neopentyl glycol, 1,6-hexanediol, 2-butyl-2-ethyl-1,3-propanediol, 1,4-cyclohexanedimethanol, diethylene glycol, 1,3-propanediol, ethylene glycol, propylene glycol, 2,4-dimethyl-2-ethylhexane-1,3-diol, 2-ethyl-isobutyl-1,3-propanediol, 1,3-butanediol, 1,4-butanediol, 1,5-pentanediol, 3-methyl-1,5-pentanediol, methylpropanediol, 2-methyl-1,3-propanediol, dipropylene glycol, 1,9-nonanediol, glycerol, or the like. These may be used each alone or in a combination thereof. In an exemplary embodiment, the diol compound may include neopentyl glycol.

The caprolactone polyol may include caprolactone triol. Caprolactone triol may impart elasticity to a coating layer and improve the restorability against scratches. Since caprolactone triol has a lower molecular weight and a higher hydroxyl group content than other polyols, the cross-linked density and the content of network structure may be increased. Accordingly, the elasticity of a coating layer may be enhanced.

For example, the caprolactone triol may be represented by the following Chemical Formula 8.

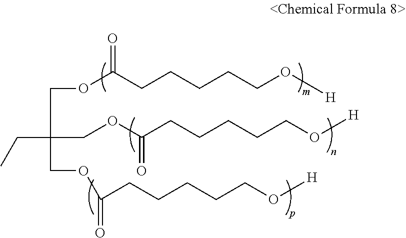

In Chemical Formula 8, each of m, n and p independently represent a natural number, which has a corresponding value depending on the molecular weight.

For example, the polyfunctional acid or the derivative thereof may include an aromatic divalent acid/acid derivative, n aliphatic divalent acid/acid derivative or an alicyclic divalent acid/acid derivative.

For example, the aromatic divalent acid/acid derivative may include terephthalic acid, phthalic acid, phthalic anhydride, dimethylterephthalic acid, naphthalene dicarboxylate, tetrachlorophthalic acid, terephthalic acid bisglycol ester, isophthalic acid, t-butyl isophthalic acid, or the like. The aliphatic divalent acid/acid derivative may include, e.g., fumaric acid, adipic acid, azelaic acid, sebacic acid, dodecanoic acid, glutaric acid, succinic acid, oxalic acid, itaconic acid, dimeric, fatty acid, maleic anhydride, succinic acid anhydride, chlorendic acid, diglycolic acid, pimelic acid, suberic acid, or the like. The alicyclic divalent acid/acid derivative may include, e.g., 1,4-cyclohexanedicarboxylic acid, 1,3-cyclohexanedicarboxylic acid, hexahydrophthalic anhydride, dimethyl cyclohexanedicarboxylate, or the like. These may be used each alone or in a combination thereof.

In an exemplary embodiment, the polyfunctional acid or the derivative thereof may include the alicyclic divalent acid/acid derivative. The polyfunctional acid or the derivative thereof may include, e.g., dimethyl cyclohexanedicarboxylate.

In an exemplary embodiment, the polyfunctional acid or the derivative thereof may include the aliphatic divalent acid/acid derivative.

Preferably, the alicyclic divalent acid/acid derivative may participate in a first reaction (exchange reaction), and the aliphatic divalent acid/acid derivative may participate in a second reaction (symmetric reaction). When the alicyclic divalent acid/acid derivative and the aliphatic divalent acid/acid derivative participate in the same reaction, it is difficult to obtain a polyol having a symmetrical structure.

For example, after a reaction of carprolactone triol, neopentyl glycol and dimethyl cyclohexanedicarboxylate (ester exchange reaction) to obtain a branched polyol, and then the prepolyol may be reacted with adipic acid to obtain the caprolactone-modified hyperbranched polyester polyol having a symmetrical structure.

For example, the polyol obtained by the ester exchange reaction may be represented by the following Chemical Formula 9.

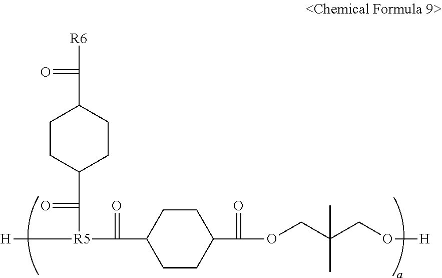

In Chemical Formula 9, R5 and R6 are moieties derived from caprolactone triol. R5 is a trivalent group, and R6 has two hydroxyl groups. a represents a natural number. For example, R5 and R6 may be represented by the following Chemical Formulas 10 and 11, respectively.

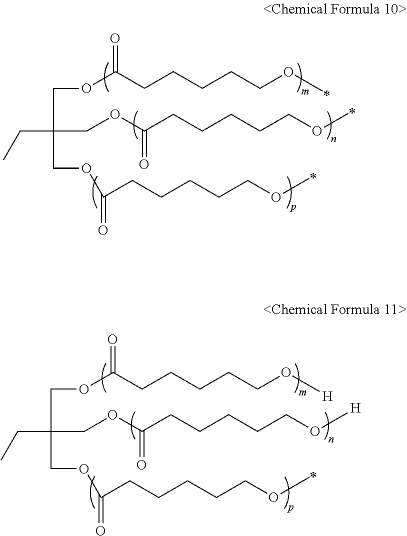

In Chemical Formulas 10 and 11, each of m, n and p independently represent a natural number.

The polyol of Chemical Formula 9 may react with an alicyclic polyvalent acid/acid derivative to form the caprolactone-modified hyperbranched polyester polyol having a symmetrical structure. For example, the caprolactone-modified hyperbranched polyester polyol may be represented by the following Chemical Formula 12.

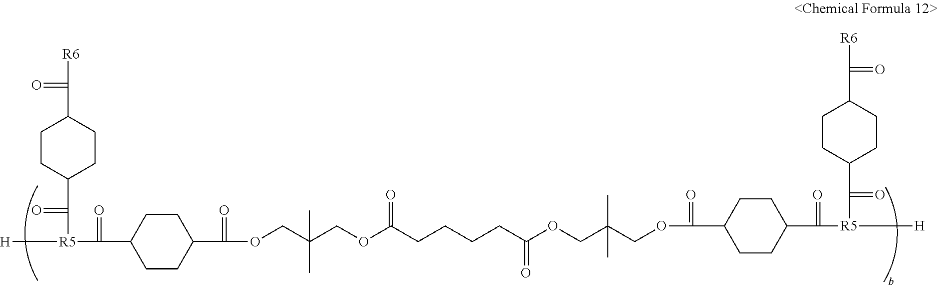

In Chemical Formula 12, R5 and R6 are moieties derived from caprolactone triol. R5 is a trivalent group, and R6 has two hydroxyl groups. b represents a natural number.

The caprolactone-modified hyperbranched polyester polyol having such a symmetrical structure has high elasticity of the resin itself, and thus may improve the elasticity and mechanical properties of a coating layer.

In an exemplary embodiment, the caprolactone-modified hyperbranched polyester polyol may have an acid value of 10 mg/KOH or less, a hydroxyl group content of 6% to 8%, and a weight average molecular weight of 500 to 2,000. The caprolactone-modified hyperbranched polyester polyol has softness properties as a resin in itself and forms a network structure by a cross-linking reaction with a curing agent. Thus, a strength of a coating layer may be enhanced. Also, the caprolactone-modified hyperbranched polyester polyol may have softness properties thereby increasing an impact resistance.

For example, the content of the caprolactone-modified hyperbranched polyester polyol may be 5 wt % to 20 wt % based on the total weight of the coating composition. When the content of the caprolactone-modified hyperbranched polyester polyol is less than 5 wt %, it is difficult to obtain the effect of improving strength, and when the content of the caprolactone-modified hyperbranched polyester polyol is more than 20 wt %, the washing-resistance may be deteriorated.

The coating layer formed using the caprolactone-modified hyperbranched polyester polyol may have excellent strength and high gloss. Also, a polishing operation for gloss may be easily performed, and breakage or damage by external force may be prevented since an impact resistance is excellent. In addition, since the flowability is great during the coating operation, the appearance of the coated object may be improved.

(b) First Acrylic Resin

The first acrylic resin may be obtained by a radical polymerization of monomers a having vinyl-type double bond. The monomers may include various types of monomers, and may include at least a caprolactone-modified (meth)acrylate.

For example, the caprolactone-modified (meth)acrylate may be represented by the following Chemical Formula 13.

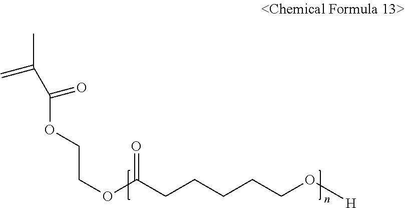

In Chemical Formula 13, n represents a natural number. For example, n may be a natural number from 1 to 10.

The softness and strength characteristics of the resin may be controlled according to the number of n, that is, the length of a chain derived from caprolactone. For example, when the chain length is longer, the distance between the crystalline portion (cross-linking region) and non-crystalline portion may increase during the curing reaction, and the elasticity may increase.

The monomer mixture may include, in addition to the caprolactone-modified (meth)acrylate, at least one of aliphatic methacrylate, aliphatic acrylate, methacrylate having a hydroxyl group, (meth)acrylic acid and aromatic acrylate.

The aliphatic methacrylate may include, e.g., butyl methacrylate, methyl methacrylate, ethyl methacrylate, 2-ethylhexyl methacrylate, lauryl methacrylate, isobornyl methacrylate, cyclohexyl methacrylate, or the like. The aliphatic acrylate may include, e.g., butyl acrylate, methyl acrylate, ethyl acrylate, acrylate, or the like. The methacrylate having a hydroxyl group may include, e.g., 2-hydroxyethyl methacrylate, 2-hydroxypropyl methacrylate, or the like. The aromatic acrylate may include, e.g., styrene monomer. These may be used each alone or in a combination thereof.

In an exemplary embodiment, in the monomer mixture, the content of a monomer having a hydroxyl group, that is, the sum of the content of methacrylate having a hydroxyl group and the content of the caprolactone-modified (meth)acrylate may be 20 wt % to 50 wt % based on the total weight of the monomer mixture. When the content of the monomer having a hydroxyl group is less than 20 wt %, the cross-linking density may be lowered and the strength may be deteriorated, and when the content of the monomer having a hydroxyl group is more than 50 wt %, the cross-linking density may be excessively increase and the scratch-resistance of a coating layer may be deteriorated, and the storage stability of the coating composition and the compatibility with the solvent may be deteriorated.

Particularly, in an exemplary embodiment, the monomer mixture may include aliphatic methacrylate of 20 wt % to 50 wt %, methacrylate having a hydroxyl group of 20 wt % to 50 wt %, (meth)acrylic acid of 0.1 wt % to 3 wt %, aliphatic acrylate of 5 wt % to 20 wt %, caprolactone-modified (meth)acrylate of 10 wt % to 20 wt % and aromatic acrylate of 10 wt % to 20 wt %.

In order to proceed with a polymerization of the monomer mixture, a radical polymerization initiator may be used. The radical polymerization initiator may include, e.g., benzoyl peroxide, tertiary butyl peroxybenzoate, tertiarybutyl peroxy-2-ethyl hexanoate, tertiary amyl peroxy-2-ethyl hexanoate, or the like. These may be used each alone or in a combination thereof.

The content of the polymerization initiator may be 3 to 10 parts by weight with respect to 100 parts by weight of the monomer mixture.

The polymerization of the monomer mixture may proceed in an organic solvent. The organic solvent may include, e.g., aromatic hydrocarbons such as toluene, xylene, or the like, esters such as N-butyl acetate, ethylene glycol ethyl ether acetate, or the like, ketones such as methyl isobutyl ketone, methyl-N-amyl ketone, or the like, and the high the reaction temperature, the lower the molecular weight of the resin, so that high boiling point to medium boiling point solvents may be used each alone or in a combination thereof. For example, in consideration of the synthesis temperature and the evaporation rate of the resin, it may be preferable to progress with synthesis at 100° C. to 150° C. using a solvent having a boiling point of 100° C. to 160° C.

In an exemplary embodiment, the first acrylic resin may be represented by the following Chemical Formula 14.

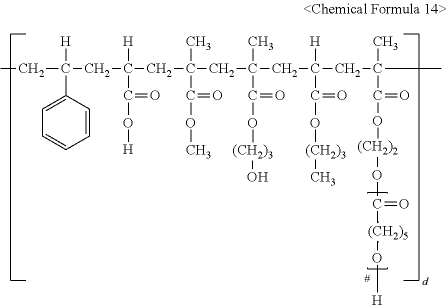

In Formula 14, d represents a natural number.

In an exemplary embodiment, the first acrylic resin may have a solid content of 60% to 70%, a weight average molecular weight of 5,000 to 12,000, a hydroxyl group content of 4% to 6%, and a glass transition temperature of 10° C. to 20° C.

In an exemplary embodiment, the content of the first acrylic resin may be 30 wt % to 50 wt %, and more preferably 40 wt % to 50 wt % based on the total weight of the coating composition. When the content of the first acrylic resin is less than 40 wt %, a washing resistance may be lowered, and when the content of the first acrylic resin is more than 50 wt %, an acid resistance may be lowered.

The caprolactone-modified (meth)acrylate has softness properties, may prevent scratches of a coating layer, and may provide self-restoration force against scratches.

(c) A Second Acrylic Resin

The second acrylic resin may be obtained by a radical polymerization of monomers having a vinyl-type double bond. The monomers may include various types of monomers, and may not include a caprolactone-modified (meth)acrylate.

The second acrylic resin may include at least one of aliphatic methacrylate, aliphatic acrylate, methacrylate having a hydroxyl group, (meth)acrylic acid and aromatic acrylate.

The aliphatic methacrylate may include, e.g., butyl methacrylate, methyl methacrylate, ethyl methacrylate, 2-ethylhexyl methacrylate, lauryl methacrylate, isobornyl methacrylate, cyclohexyl methacrylate, or the like. The aliphatic acrylate may include, e.g., butyl acrylate, methyl acrylate, ethyl acrylate, 2-ethylhexyl acrylate or the like. The methacrylate having a hydroxyl group may include, e.g., 2-hydroxyethyl methacrylate, 2-hydroxypropyl methacrylate, or the like. The aromatic acrylate may include, e.g., styrene monomer. These may be used each alone or in a combination thereof.

In an exemplary embodiment, in the monomer mixture, the content of methacrylate having a hydroxyl group may be 20 wt % to 40 wt % based on the total weight of the monomer mixture. When the content of methacrylate having a hydroxyl group is less than 20 wt %, the cross-linking density may be lowered and the strength may be deteriorated, and when the content of methacrylate having a hydroxyl group is more than 40 wt %, the cross-linking density may be excessively increase and the scratch-resistance of a coating layer may be deteriorated, and the storage stability of the coating composition and the compatibility with the solvent may be deteriorated.

Particularly, in an exemplary embodiment, the monomer mixture may include aliphatic methacrylate of 20 wt % to 50 wt %, methacrylate having a hydroxyl group of 20 wt % to 40 wt %, (meth)acrylic acid of 0.1 wt % to 3 wt %, aliphatic acrylate of 5 wt % to 20 wt %, and aromatic acrylate of 10 wt % to 25 wt %.

In order to proceed with a polymerization of the monomer mixture, a radical polymerization initiator may be used and the polymerization of the monomer mixture may proceed in an organic solvent. The initiator, the organic solvent and reaction conditions used in the reaction may be similar to the synthesis of the first acrylic resin.

In an exemplary embodiment, the second acrylic resin may have a lower hydroxyl group content and a higher glass transition temperature than the first acrylic resin.

The second acrylic resin may have a solid content of 55% to 65%, a weight average molecular weight of 8,000 to 20,000, a hydroxyl group content of 3% to 5%, and a glass transition temperature of 40° C. to 50° C.

In an exemplary embodiment, the content of the second acrylic resin may be 15 wt % to 25 wt % based on the total weight of the coating composition. When the content of the second acrylic resin is less than 15 wt %, a washing resistance may be lowered, and when the content of the second acrylic resin is more than 25 wt %, an acid resistance may be lowered.

(d) A Solvent

The solvent may control viscosity to enable coating of the composition and improve evenness of a coating layer. The solvent may include, e.g., aromatic hydrocarbons such as toluene, xylene, or the like, esters such as N-butyl acetate, ethylene glycol ethyl ether acetate, or the like, ketones such as methyl isobutyl ketone, methyl-N-amyl ketone, or the like.

For example, the content of the solvent may be 10 wt % to 40 wt %, and preferably 10 wt % to 30 wt %.

(e) Additives

The additives may include, e.g., a wetting agent, a light stabilizer, a reaction catalyst, or the like. The wetting agent may improve a wettability and a leveling property of a coating layer. For example, a polydimethylsiloxane-based wetting agent such as BYK-306 may be used as the wetting agent.

The light stabilizer may increase a light resistance of a coating layer and may improve a weather resistance. The light stabilizer may be an ultraviolet absorber (UVA) or a radical scavenger. For example, Tinuvin 1130 that is an ultraviolet absorber (UNA), or Tinuvin 202 of a hindered amine (HAILS) series that is a radical scavenger may be used as the light stabilizer. These may be used each alone or in a combination thereof, and may be preferably used in combinations.

The reaction catalyst may be a urethane reaction catalyst, which may improve the reaction rate of a hydroxyl group with an isocyanate group. The reaction catalyst may be dibutyl tin dilaurate, dibutyl tin oxide, or the like.

For example, the content of the wetting agent may be 0.1 wt % to 1 wt %, and the content of the light stabilizer may be 0.1 wt % to 1.5 wt %. The content of the reaction catalyst may be 0.1 wt % to 1.5 wt %.

For example, the content of the curing agent may be 30 to 90 parts by weight with respect to 100 parts by weight of the main agent, and preferably 30 to 70 parts by weight

The coating composition may be cured by heat. For example, it may be thermally cured at about 130° C. to 180° C. to form a cured coating layer.

The coating composition may form a coating layer having scratch resistance and self-restorability. When the coating composition is used for forming a coating layer for an exterior coating of an automobile, the coating layer may be self-restored against scratches caused by washing, external environment, or the like.

The coating composition may be used for forming a clear layer (a transparent layer) of an automotive exterior coating. For example, the automotive exterior coating may be performed by the following processes.

First, an object to be coated (an iron plate) may be pretreated. The pretreatment may be a degreasing treatment applying an acid. Thereafter, impurities such as acids may be removed by a washing process. Thereafter, electro-deposition coating may be performed. The electro-deposition coating may be performed by immersing the object in an electro-deposition paint (water-soluble) and applying a voltage to electrochemically form a coating layer. The coating layer may be cured by heat. For example, it may be thermally cured at about 130° C. to 180° C., thereby forming a base coating layer (undercoating layer). The base coating layer may impart an erosion resistance to the object.

A middle primer layer may be formed on the base coating layer, and a base color layer (for example, a black color layer) may be formed on the primer layer.

The middle primer layer may impart a flatness, a light-blocking ability or the like to the object. A coating composition for the middle primer layer may be an oil-based paint or an aqueous paint. For example, the paints for the middle primer may preferably include an alkyd resin, a polyester resin, a melamine resin, a polyurethane resin or the like. Monomers for forming the above resins may include trimethylol propane, phthalic anhydride, isophthalic acid, hexahydrophthalic acid, caprolactone or the like. The paints for the middle primer layer may further include a pigment such as carbon black, titanium oxide or the like to increase a light-blocking ability.

A coating composition according to the above-explained embodiments may be coated on the base color layer and thermally cured to form a transparent coating layer.

Hereinafter, effects of coating compositions according to exemplary embodiments and a method for forming a coating layer sing the same will be described more fully with reference to specific comparative examples, examples and experiments.

### Polyisocyanate Curing Agent

### Synthesis Example 1—Elastic Polyisocyanate

215 parts by weight of neopentyl glycol, 200 parts by weight of 1,6-hexanediol, 88 parts by weight of 1,3-propanediol, 110 parts by weight of 1,4-butanediol and 560 parts by weight of adipic acid were added to a four-necked flask equipped with a stirrer, and the temperature was gradually elevated to 150° C. Thereafter, the mixture was aged at 150° C. for 2 hours while removing alcohol. Thereafter, the temperature was elevated to 220° C. over 3 hours, and maintained until reaching at 90% or more of theoretical dealcoholization amount to obtain a polyester alcohol.

Thereafter, 730 parts by weight of 1,6-hexamethylene diisocyanate and 280 parts by weight of the polyester polyol were added to a four-necked flask equipped with a stirrer, and the temperature was elevated to 150° C. over 2 hours. Thereafter, the temperature was maintained for 8 hours to proceed with reaction. When the desired NCO % was achieved, the reaction was terminated.

The reaction product was distillation-purified by using a thin film evaporator. In the distillation purification, the pressure was 0.5 to 1 kPa, and the temperature was 140° C. to 160° C. The content of diisocyanate remaining in a polyisocyanate purified through the above process was equal to or less than 0.5 wt %.

Thus obtained polyisocyanate was mixed with toluene and PMAc to prepare a curing agent having 75 wt % of a solid content, 6 wt % to 7 wt % of an NCO content and 150 mPa·s of a viscosity at 25° C.

### Synthesis Example 2—Elastic Polyisocyanate

360 parts by weight of 1,3-butanediol, 226 parts by weight of trimethylol propane and 575 parts by weight of adipic acid were added to a four-necked flask equipped with a stirrer, and the temperature was gradually elevated to 150° C. Thereafter, the mixture was aged at 150° C. for 2 hours while removing alcohol. Thereafter, the temperature was elevated to 220° C. over 3 hours, and maintained until reaching at 90% or more of theoretical dealcoholization amount to obtain a polyester alcohol.

Thereafter, 680 parts by weight of 1,6-hexamethylene diisocyanate and 200 parts by weight of the polyester polyol were added to a four-necked flask equipped with a stirrer, and the temperature was elevated to 120° C. over 2 hours. Thereafter, the temperature was maintained for 8 hours to proceed with reaction. When the desired NCO % was achieved, the reaction was terminated.

The reaction product was distillation-purified by using a thin film evaporator. In the distillation purification, the pressure was 0.5 to 1 kPa, and the temperature was 140° C. to 160° C. The content of diisocyanate remaining in a polyisocyanate purified through the above process was equal to or less than 0.5 wt %.

Thus obtained polyisocyanate was mixed with n-butylacetate to prepare a curing agent having 80 wt % of a solid content, 7 wt % to 8 wt % of an NCO content and 350 mPa·s of a viscosity at 25° C.

### Main Agent

### Synthesis Example 3—A Caprolactone-Modified Hyperbranched Polyester Polyol

200 parts by weight of dimethylcyclohexanedicarboxylate (Eastman), 450 parts by weight of caprolactone triol CAPA 3031 (Perstorp), 45 parts by weight of neopentyl glycol, 0.1 part by weight of dibutlytin oxide, 1 part by weight of p-toluenesulfonic acid monohydrate were added to a four-necked flask equipped with a stirrer, and the temperature was gradually elevated to 170° C. Thereafter, the mixture was aged at 170° C. for 2 hours while removing condensed water and alcohol. Thereafter, the temperature was elevated to 190° C., and maintained until reaching at 90% or more of theoretical dealcoholization amount.

Thereafter, after cooling the mixture to 150° C., 73 parts by weight of adipic acid was added. Thereafter, the mixture was heated up to 170° C., maintained for 2 hours, heated up to 220° C. over 3 hours, and aged for 1 hour. Thereafter, the mixture was refluxed using xylene to remove the condensed water, and when the acid value became 10 or less, the mixture was cooled to 180° C. and vacuum decompression was performed to remove xylene. Thereafter, the mixture was cooled, and 290 parts by weight of butyl acetate was added as a solvent at 120° C. or lower. As a result, a symmetrical hyperbranched polyester polyol having a solid content of 70% and a hydroxyl group content of 6% was obtained.

### Synthesis Example 4—A First Acrylic Resin

After adding 196 g of n-butyl acetate as a solvent to a four-necked flask equipped with a stirrer, a gas in the flask was exchanged with nitrogen gas, the flask was stirred and heated to 120° C. and kept constant. After a mixture in which 110 g of butyl acrylate as an aliphatic acrylate, 150 g of butyl methacrylate as an aliphatic methacrylate, 280 g of 2-hydroxypropyl methacrylate as a methacrylate having a hydroxyl group, 115 g of Miramer M100 (Miwon) as a caprolactone-modified (meth)acrylate, 10 g of acrylic acid, 137 g of styrene monomer as an aromatic acrylate, 78 g of tert-butyl peroxy-2-ethylhexanoate as an initiator were mixed was added to the solvent at a uniform dropping rate over 5 hours, the mixture was further aged at a reaction temperature of 120° C. for 1 hour after the addition. Thereafter, a solution including 9 g of tert-butyl peroxy-2-ethylhexanoate dissolved in 24 g of n-butyl acetate was added thereto and stirred for 2 hours so that the unreacted monomer was reacted. Thereafter, the mixture was diluted with 169 g of n-butyl acetate to obtain a caprolactone-modified acrylic resin. The caprolactone-modified acrylic resin had a weight average molecular weight of about 5,000 to 12,000, a hydroxyl value of 150 mgKOH/g to 170 mgKOH/g (solid content), a solid content of 65%, and a glass transition temperature of 10° C. to 20° C.

### Synthesis Example 5—A Second Acrylic Resin

After adding 240 g of n-butyl acetate as a solvent to a four-necked flask equipped with a stirrer, a gas in the flask was exchanged with nitrogen gas, the flask was stirred and heated to 120° C. and kept constant. After a mixture in which 64 g of butyl acrylate as an aliphatic acrylate, 240 g of butyl methacrylate and 152 g of methyl methacrylate as an aliphatic methacrylate, 176 g of 2-hydroxyethyl methacrylate as a methacrylate having a hydroxyl group, 8 g of methacrylic acid, 160 g of styrene monomer as an aromatic acrylate, 88 g of tert-butyl peroxy-2-ethylhexanoate as an initiator were mixed was added to the solvent at a uniform dropping rate over 5 hours, the mixture was further aged at a reaction temperature of 120° C. for 1 hour. Thereafter, a solution including 4 g of tert-butyl peroxy-2-ethylhexanoate dissolved in 24 g of n-butyl acetate was added thereto and stirred for 2 hours so that the unreacted monomer was reacted. Thereafter, the mixture was diluted with 248 g of n-butyl acetate to obtain an acrylic resin. The acrylic resin had a weight average molecular weight of about 8,000 to 20,000, a hydroxyl value of 130 mgKOH/g to 140 mgKOH/g (solid content), a solid content of 60%, and a glass transition temperature of 40° C. to 50° C.

10 wt % of the polyol of Synthetic Example 3, 40 wt % of the acrylic resin of Synthetic Example 4, 20 wt % of the acrylic resin of Synthetic Example 5, 1 wt % of dibutyl tin dilaurate, 1 wt % of BYK-306 (BYK) as wetting agent, 1.2 wt % a mixture of TINUVIN 1130 and TINUVIN 292 as light stabilizer and extra solvent (butyl acetate and xylene) were mixed to prepare a main agent.

Forming a Coating Layer

The main agent, the curing agent of Synthetic Example 1, the curing agent of Synthetic Example 2 and HDI trimer (68 wt % of content, solvent: n-butylacetate) were mixed according to the following Table 1 (unit: parts by weight). The gloss, the chemical resistance, the heat resistance, the solvent resistance, the water resistance, the acid resistance, the impact resistance and the weather resistance of coating layers, which was obtained by the mixtures and thermally cured at 140° C. for 30 minutes, were measured or evaluated and then represented by the following Tables 2 and 3, wherein ⊚ represents “excellent”, ◯ represents “good”, Δ represents “not bad”, and X represents “bad”.

TABLE 1

| | Main | Synthetic | Synthetic | HDI |
|---|---|---|---|---|
| | agent | Example 1 | Example 2 | trimer |
| Example 1 | 116.8 | 95.5 | — | 0 |
| Example 2 | 116.8 | 46.8 | — | 20.0 |
| Example 3 | 116.8 | 27.8 | — | 27.8 |
| Example 4 | 116.8 | 14.3 | — | 33.4 |
| Example 5 | 116.8 | — | 73.0 | 0 |
| Example 6 | 116.8 | — | 40.3 | 17.3 |
| Example 7 | 116.8 | — | 25.4 | 25.4 |
| Example 8 | 116.8 | — | 13.7 | 31.9 |
| Comparative | 116.8 | — | — | 38.9 |
| Example 1 | | | | |

TABLE 2

| | Gloss | Gloss-maintaining ratio (%) | | | |
|---|---|---|---|---|---|
| | before | Right after | 25° C. | 55° C. | 75° C. |
| | washed | washed | 48 h | 20 h | 16 h |
| Example 1 | 91.3 | 98.1 | 98.6 | 98.9 | 98.6 |
| Example 2 | 93.5 | 95.2 | 95.7 | 95.2 | 96.1 |
| Example 3 | 94.4 | 95.2 | 95.3 | 95.6 | 95.5 |
| Example 4 | 95.2 | 94.8 | 94.8 | 95.1 | 95.3 |
| Example 5 | 92.6 | 97.5 | 97.6 | 97.8 | 97.7 |
| Example 6 | 93.3 | 97.0 | 97.0 | 97.5 | 97.6 |
| Example 7 | 94.4 | 95.0 | 95.4 | 95.2 | 95.2 |
| Example 8 | 94.5 | 94.2 | 94.4 | 94.6 | 94.5 |
| Comparative | 96.0 | 88.3 | 88.9 | 89.3 | 89.0 |
| Example 1 | | | | | |

TABLE 3

| | Chemical | Heat | Solvent | Water | Acid | Impact | Weather |
|---|---|---|---|---|---|---|---|
| | resistance | resistance | resistance | resistance | resistance | resistance | resistance |
| Example 1 | ⊚ | ⊚ | Δ | ⊚ | ⊚ | ⊚ | ⊚ |
| Example 2 | ⊚ | ⊚ | ◯ | ⊚ | ⊚ | ⊚ | ⊚ |
| Example 3 | ⊚ | ⊚ | ◯ | ⊚ | ⊚ | ⊚ | ⊚ |
| Example 4 | ⊚ | ⊚ | ⊚ | ⊚ | ⊚ | ⊚ | ⊚ |
| Example 5 | ⊚ | ⊚ | Δ | ⊚ | ⊚ | ⊚ | ⊚ |
| Example 6 | ⊚ | ⊚ | ◯ | ⊚ | ⊚ | ⊚ | ⊚ |
| Example 7 | ⊚ | ⊚ | ◯ | ⊚ | ⊚ | ⊚ | ⊚ |
| Example 8 | ⊚ | ⊚ | ◯ | ⊚ | ⊚ | ⊚ | ⊚ |
| Comparative | ⊚ | ⊚ | ⊚ | ⊚ | ⊚ | ⊚ | ⊚ |
| Example 1 | | | | | | | |

In order to evaluate the water resistance, the sample was immersed in a water bath at about 50° C. for 240 hours, and taken out to evaluate appearance and initial adhesion.

In order to evaluate the impact resistance, an impact was applied at a height of 50 cm and a load of 1 kg by using a fall drop tester of ISO 6272, and appearance and initial adhesion were evaluated.

In order to evaluate the acid resistance, 0.2 ml of 0.5% sulfuric acid and 0.1N of prescribed hydrochloric acid were dropped onto a surface of a coating layer, and a coating layer was allowed to stand at room temperature for 24 hours and then washed with water to evaluate appearance changes.

In order to evaluate the chemical resistance, the sample was rubbed back and forth 10 times with a force of 5N using prescribed chemicals, and then left in a thermostatic chamber at about 80° C. for 3 hours to evaluate the surface state of the sample.

In order to evaluate the heat resistance, the sample was allowed to stand in a chamber of about 90° C. for 300 hours, and then the appearance and initial adhesion of the sample were evaluated.

In order to evaluate the weather resistance, appearance change was observed after irradiation of 2500 kJ/m² according to SAE J1960.

In order to evaluate the solvent resistance, after a cotton piece (5 cm×5 cm) was disposed on the sample, about 1.5 g of xylene was sprayed. The surface of the sample was observed for 5 minutes by 1 minute.

In order to evaluate the washing resistance, after initial gloss was measured, the sample was mounted on a test stand and the prescribed Dust solution was continuously sprayed after agitation, and a polystyrene brush was reciprocated 10 times at a moving speed of 5 m/min. Next, the sample was washed with soapy water, left at room temperature, and then impurities on the surface of the sample were removed with an organic cleaning agent. Thereafter, the gloss of the sample was measured by a BYK micro glossmeter according to ISO 2813 with 60 degrees. The gloss-maintaining ratio was defined by (gloss after washed/gloss before washed)×100%.

Referring to Tables 2 and 3, the gloss-maintaining ratio of the coating layers obtained by Examples 1 and 8 was remarkably increased with compared to that of the coating layer obtained by Comparative Example 1 using only the trimer as a curing agent. Thus, it can be noted that the curing agent and the coating composition according to exemplary embodiments of the present invention may form a coating layer having superior scratch resistance and self-restorability.

Furthermore, when the curing agent of Synthetic Example 1 or 2 was solely used, the solvent resistance and the initial gloss were lowered. Thus, it can be noted that using the curing agent with a proper amount of HDI trimer may the solvent resistance and the initial gloss of the coating layer.

The above coating composition may be used for coating a product having a metal exterior such as an automobile, a mobile phone, a home appliance or the like.

As described above, although the present invention has been described with reference to exemplary embodiments, those skilled in the art will readily appreciate that many modifications are possible in the exemplary embodiments without materially departing from the novel teachings and advantages of the present inventive concept.

What is claimed is:

1. A curing agent including a polyisocyanate obtained by reaction of a polyester polyol and a diisocyanate, the polyester polyol having 500 to 2,000 of a weight average molecular weight and 5% to 10% of a hydroxyl group content.

2. The curing agent of claim 1, wherein the polyester polyol is represented by the following Chemical Formula 1, wherein each of a, b, c, d, e, f and g independently represent a natural number.

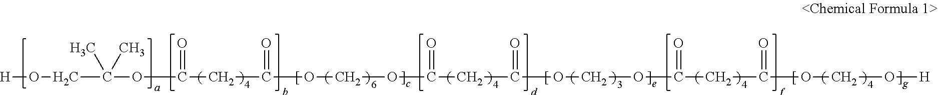

3. The curing agent of claim 2, wherein the curing agent has a solid content of 73 wt % to 77 wt %, an NCO content of 6 wt % to 7 wt % and a viscosity of 100 to 200 mPa·s at 25° C.

4. The curing agent of claim 1, wherein the polyester polyol is represented by the following Chemical Formula 2, wherein each of p, q and r independently represent a natural number.

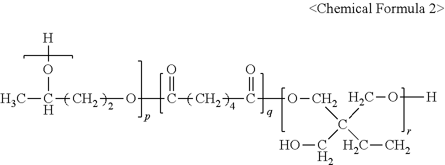

5. The curing agent of claim 4, wherein the curing agent has a solid content of 78 wt % to 82 wt %, an NCO content of 7 wt % to 8 wt % and a viscosity of 300 to 400 mPa·s at 25° C.

6. The curing agent of claim 1, further including 200 to 250 parts by weight of hexamethylene diisocyanate trimer with respect to 100 parts by weight of a solid content of the polyisocyanate.

7. The curing agent of claim 1, wherein the diisocyanate is an aliphatic diisocyanate.

8. A coating composition for forming a self-restoring layer including:
a main agent; and
the curing agent of claim 1,
wherein the main agent includes:
5 wt % to 20 wt % of a caprolactone-modified hyperbranched polyester polyol, the caprolactone-modified hyperbranched polyester polyol obtained from a polyhydric alcohol including caprolactone triol;
30 wt % to 50 wt % of a first acrylic resin having a hydroxyl group;
15 wt % to 25 wt % of a second acrylic resin having a hydroxyl group and having a glass transition temperature higher than that of the first acrylic resin; and
an extra solvent.

9. The coating composition of claim 8, wherein the caprolactone-modified hyperbranched polyester polyol has an acid value of 10 mg/KOH or less, a hydroxyl group content of 6% to 8%, and a weight average molecular weight of 1,000 to 2,000.

10. The coating composition of claim 8, wherein the first acrylic resin has a solid content of 60% to 70%, a weight average molecular weight of 5,000 to 12,000, a hydroxyl group content of 4% to 6%, and a glass transition temperature of 10° C. to 20° C.

11. The coating composition of claim 10, wherein the first acrylic resin is obtained by a radical polymerization of a monomer mixture including aliphatic methacrylate of 20 wt % to 50 wt %, methacrylate having a hydroxyl group of 20 wt % to 50 wt %, (meth)acrylic acid of 0.1 wt % to 3 wt %, aliphatic acrylate of 5 wt % to 20 wt %, caprolactone-modified (meth)acrylate of 10 wt % to 20 wt % and aromatic acrylate of 10 wt % to 20 wt %.

12. The coating composition of claim 8, wherein the second acrylic resin has a solid content of 55% to 65%, a weight average molecular weight of 8,000 to 20,000, a hydroxyl group content of 3% to 5%, and a glass transition temperature of 40° C. to 50° C.

13. The coating composition of claim 12, wherein the second acrylic resin is obtained by a radical polymerization of a monomer mixture including aliphatic methacrylate of 20 wt % to 50 wt %, methacrylate having a hydroxyl group of 20 wt % to 40 wt %, (meth)acrylic acid of 0.1 wt % to 3 wt %, aliphatic acrylate of 5 wt % to 20 wt % and aromatic acrylate of 10 wt % to 25 wt %.

14. A method for coating an automobile exterior, including:
pretreating a surface of an object to be coated;
forming an electro-deposited layer on the surface of the object;
forming a middle primer layer on the electro-deposited layer;
forming a base color layer on the middle primer layer;
coating the coating composition of claim 8 on the base color layer; and
heat-treating the coating composition to form a cured coating layer.
